(19) United States
(12) Patent Application Publication
(10) Pub. No.: US 2023/0368316 A1
(43) Pub. Date: Nov. 16, 2023

(54) HOUSING BUSINESS ASSISTANCE DEVICE, HOUSING BUSINESS ASSISTANCE METHOD, AND RECORDING MEDIUM

(71) Applicant: NEC Corporation, Minato-ku, Tokyo (JP)

(72) Inventors: Satoshi SAKAKIBARA, Tokyo (JP); Yusuke Iwasaki; Akio Kawachi, Tokyo (JP); Yuya Hanzawa, Tokyo (JP); Xiaoyu Song, Tokyo (JP)

(73) Assignee: NEC Corporation, Minato-ku, Tokyo (JP)

(21) Appl. No.: 18/026,045

(22) PCT Filed: Sep. 23, 2020
(86) PCT No.: PCT/JP2020/035668

§ 371 Date: Mar. 13, 2023

(51) Int. Cl. G06Q 50/16; G06Q 30/0204

(52) U.S. Cl. CPC G06Q 50/163; G06Q 30/0204

(57) ABSTRACT

A housing business assistance device includes: a memory; and at least one processor coupled to the memory. The processor performs operations. The operations includes: calculating a first difference between a value indicating a customer of a target company and a value indicating a customer of a company other than the target company for each segment obtained by classifying target customers of a housing-related business into a plurality of layers; determining a target segment for which measures are to be taken using the first difference; determining a transition destination segment to which a value indicating a customer of the target company in the target segment transitions; deriving one or more variables serving as keys in the measures using the target segment and the transition destination segment as inputs; and extracting one or more measure candidates associated with the variables.

### TECHNICAL FIELD

The present invention relates to a housing business assistance device and the like for supporting housing-related business activities.

### BACKGROUND ART

There is a system that supports business activities for selling various merchandise. Patent Literature 1 discloses a technique for presenting a most effective business activity plan according to a sales situation by accumulating sales know-how. Patent Literature 2 discloses a technique for optimizing mass marketing measures for an unspecified number of targets. Patent Literature 3 discloses a technique for deriving a strategy from customer data to induce customers to a customer segment with a higher customer lifetime value. In addition, Patent Literature 4 discloses a method of heterogeneous mixed learning.

### CITATION LIST

### Patent Literature

[PTL 1] JP 10-124584 A
[PTL 2] JP 2015-191375 A
[PTL 3] JP 2003-022359 A
[PTL 4] Specification of US 2014/0222741 A

### SUMMARY OF INVENTION

### Technical Problem

However, none of the contents disclosed in Patent Literatures 1 to 4 is specialized for housing-related business. In residential business that continues to conduct business from many directions (for example, newly constructed detached houses, house renovation, after-care services) to one customer for several 10 years, the business methods described in Patent Literatures 1 to 4 may not be applied.

In residential business, a sales person takes measures to acquire a new contract for an existing customer or a new customer, such as holding an event related to a newly constructed detached house, house renovation, or after-care service, direct mail transmission, or a discount campaign. However, it is not clear what kind of measures should be taken to receive the response from what kind of customer. Furthermore, it is not clear what kind of customer to approach will contribute to the sales improvement of the entire company. The planner of measures (sales person or the like) has to perceive the state of the customer and the market by unique experience and intuition, but since the experience and intuition cannot be visualized, even if sales increase after-care implementation of a certain measure, it is difficult to verify whether the sales increase as a result of the measure actually reaching an appropriate customer. Furthermore, although the sales person is familiar with his/her own merchandise and customers, it is difficult for the sales person to plan measures to improve sales of the entire company across a plurality of business divisions. The measure is a business strategy of driving sales of the entire company by executing a certain measure on a certain customer group.

The present disclosure has been made in view of the above problems, and one of the objects of the present disclosure is to provide a housing business assistance device or the like capable of supporting planning of appropriate measures for appropriate customers in housing-related business activities.

### Solution to Problem

In view of the above problems, a housing business assistance device according to a first aspect of the present disclosure includes: a calculation unit configured to calculate a first difference between a value indicating a customer of a target company and a value indicating a customer of a company other than the target company for each segment obtained by classifying target customers of a housing-related business into a plurality of layers; a target determination unit configured to determine a target segment for which measures are to be taken using the first difference; a transition destination determination unit configured to determine a transition destination segment to which a value indicating a customer of the target company in the target segment should transition; a derivation unit configured to derive one or more variables serving as keys in the measures using the target segment and the transition destination segment as inputs; and an extraction unit configured to extract one or more measure candidates associated with the variables.

A housing business assistance method according to a second aspect of the present disclosure includes: calculating a first difference between a value indicating a customer of a target company and a value indicating a customer of a company other than the target company for each segment obtained by classifying target customers of a housing-related business into a plurality of layers; determining a target segment for which measures are to be taken using the first difference; determining a transition destination segment to which a value indicating a customer of the target company in the target segment should transition; deriving one or more variables serving as keys in the measures using the target segment and the transition destination segment as inputs; and extracting one or more measure candidates associated with the variables.

A housing business assistance program according to a second aspect of the present disclosure causes a computer to achieve: calculating a first difference between a value indicating a customer of a target company and a value indicating a customer of a company other than the target company for each segment obtained by classifying target customers of a housing-related business into a plurality of layers; determining a target segment for which measures are to be taken using the first difference; determining a transition destination segment to which a value indicating a customer of the target company in the target segment should transition; deriving one or more variables serving as keys in the measures using the target segment and the transition destination segment as inputs; and extracting one or more measure candidates associated with the variables.

The housing business assistance program may be stored in a non-transitory computer-readable/writable recording medium.

Note that arbitrary combinations of the above components and modifications of the expressions of the present disclosure among methods, devices, systems, recording media, computer programs, and the like are also effective as aspects of the present disclosure.

In addition, various components of the present disclosure do not necessarily need to be individually independent. A plurality of constituent elements may be formed as one member, one constituent element may be formed of a plurality of members, a certain constituent element may be a part of another constituent element, a part of a certain constituent element may overlap with a part of another constituent element, and the like.

In addition, although the method and the computer program of the present disclosure describe a plurality of procedures in order, the order of description does not limit the order of executing the plurality of procedures. Therefore, when the method and the computer program of the present disclosure are implemented, the order of the plurality of procedures can be changed within a range in which there is no problem in content.

Furthermore, the plurality of procedures of the method and the computer program of the present disclosure are not limited to being executed at individually different timings. Therefore, another procedure may occur during execution of a certain procedure. The execution timing of a certain procedure and the execution timing of another procedure may partially or entirely overlap with each other.

Furthermore, the plurality of procedures of the method and the computer program of the present disclosure are not limited to being executed at individually different timings. Therefore, another procedure may occur during execution of a certain procedure. The execution timing of a certain procedure and the execution timing of another procedure may partially or entirely overlap with each other.

### Advantageous Effects of Invention

According to the present disclosure, it is possible to provide a housing business assistance device and the like that can support planning of appropriate measures for appropriate customers in housing-related business activities.

### BRIEF DESCRIPTION OF DRAWINGS

FIG. 1 is a block diagram illustrating a configuration example of a housing business assistance system according to a first example embodiment of the present disclosure.

FIG. 2 is a block diagram illustrating a configuration example of a housing business assistance device according to the first example embodiment of the present disclosure.

FIG. 3 is a diagram illustrating an example of a correspondence relationship between each segment and a question.

FIG. 4 is a diagram schematically illustrating customer layers classified for each segment.

FIG. 5 is a diagram schematically illustrating customer layers of a target company and a competitor company classified for each segment.

FIG. 6 is a graph illustrating an example of a relationship between an explanatory variable and a degree of influence.

FIG. 7 is a flowchart illustrating an operation example of the housing business assistance device according to the first example embodiment of the present disclosure.

FIG. 8 is a block diagram illustrating a configuration example of a housing business assistance device according to a second example embodiment of the present disclosure.

FIG. 9 is a diagram illustrating an example of customer distribution for each segment and each preference.

FIG. 10 is a diagram illustrating an example of the percentage of the number of customers for each segment and for each preference between a target company and a competitor company.

FIG. 11 is a diagram illustrating an example of a percentage of the number of customers for each segment and each preference in a target company.

FIG. 12 is a graph illustrating an example of a relationship between an explanatory variable and a degree of influence.

FIG. 13 is a flowchart illustrating an operation example of the housing business assistance device according to the second example embodiment of the present disclosure.

FIG. 14 is a block diagram illustrating a configuration example of a housing business assistance device according to a third example embodiment of the present disclosure.

FIG. 15 is a block diagram illustrating a configuration example of an information processing device applicable in each example embodiment.

### EXAMPLE EMBODIMENT

The customers who are the target of the residential business activity can be classified into a plurality of layers according to the current recognition state and purchase state. Examples thereof include an excellent layer, a general layer, a separation layer, an examination layer, a cognitive layer, and an unknown layer. Excellent (customer) is a customer who is aware of the company and the product and has a high purchase frequency. General (customer) is a customer who is aware of the company and the product and has a medium to low purchase frequency. Separation (customer) is a customer who is aware of the company and the product, has purchasing experience, but is dissatisfied with something and does not currently purchase. Examination (customer) is a customer who is aware of the company and the product, has no purchasing experience, but is considering purchasing. Separation (customer) may include a customer who has moved away from the state of consideration. It is assumed that a company is one of the housing service purchase candidates of the customer, and another company is selected as a consideration result. In that case, this company may regard the customer as separation (customer). Cognition state (customer) is a customer who is aware of the company and the product but has no purchase experience and is not considering purchase. Unknown (customer) is a customer who is not aware of the company and the product.

For example, a sales person of a new building business, a sales person of a renovation business, and a sales person of an after-care service business perform a residential business activity for each customer layer.

Housing-related sales activities include, for example, those related to new construction, renovation, and after-care services. Here, new construction mainly relates to a business of new detached houses (hereinafter, also referred to as new construction), and refers to, for example, custom-built houses, built-for-sale houses, or rebuilding of houses. The renovation refers to remodeling after new building and sales, for example, adding a room, installing a new wood deck, and replacing a plumbing merchandise such as a kitchen or a bath unit. Merchandise refers to all products to be sold to customers, and include newly constructed houses themselves and kitchen systems (sink and counter sets). The after-care service relates to compensation for target merchandise after new building sale, and refers to countermeasures against floor sinking, countermeasures against rain leakage, countermeasures against malfunction of plumbing fixtures, cleaning services, and the like. Note that merchandise (for example, a disposer or a ventilation fan) attached to a newly constructed house may also be included in the after-care compensation target. In after-care services, a compensation contract (a breakdown content or a compensation period to be compensated) is concluded at the time of new building sale or at the time of merchandise construction. Therefore, repair or part replacement is free or at a reduced price if the service is within the compensation, and is paid if the service is outside the compensation. In a campaign to acquire customers, after-care services may be provided free of charge or at a reduced price.

When considering measures to increase contract acquisition and improve sales of the entire company, it is necessary to consider for whom, what, and when to execute (in other words, what kind of sales activity will be performed for which customer in which layer and at which timing). For example, in a case where it is desired to conduct sales activities for renovation for excellent customers, it is effective to “implement free after-care service to general customers (breakdown or cleaning of plumbing fixtures) in August” as a measure. This is to perform free after-care inspection of a plumbing fixture in August when water is frequently used, to get a hidden request of a general customer by bringing a worker and a sales person in contact with the general customer, and to promote the general customer to an excellent customer by connecting the general customer to a contract for plumbing renovation or another contract for exterior wall painting or the like by applying a simultaneous discount.

However, a sales person of a new building business, a sales person of a renovation business, and a sales person of an after-care service business basically perform business activities separately. Therefore, although the sales person is familiar with his/her merchandise and customers, it is difficult for the sales person to plan measures to improve sales of the entire company across a plurality of business divisions.

Furthermore, in order to increase sales of the entire company, it is preferable to compare customers in each layer in an industry average or a competitor company with customers in each layer in the company, analyze strengths and weaknesses of the company, and then implement measures.

Therefore, in each example embodiment of the present disclosure, a method for supporting planning of appropriate measures for appropriate customers in housing-related business activities will be described.

In the following description, merchandise related to a detached house will be mainly described, but this can also be applied to a collective housing such as an apartment.

Hereinafter, each example embodiment will be described in detail with reference to the drawings. In the following description of the drawings, the same or similar parts are denoted by the same or similar reference numerals. However, the drawings schematically illustrate a configuration in the example embodiment of the present invention. Further, the example embodiment of the present invention described below is an example, and can be appropriately changed within the same essence.

In the example embodiment, “acquisition” includes at least one of a case where the own device goes to another device or a recording medium to acquire data or information (active acquisition), and a case where data or information output from another device is input to the own device (passive acquisition). Examples of the active acquisition include requesting or inquiring another device and receiving a reply thereto, and accessing and reading another device or a recording medium. Furthermore, examples of passive acquisition include reception of information to be distributed (alternatively, transmission, push notification, and the like). Further, “acquiring” may be selecting and acquiring from among received data or information, or selecting and receiving distributed data or information.

### First Example Embodiment

(Housing Business Assistance System)

Hereinafter, a housing business assistance system 100 according to a first example embodiment of the present disclosure will be described with reference to the drawings.

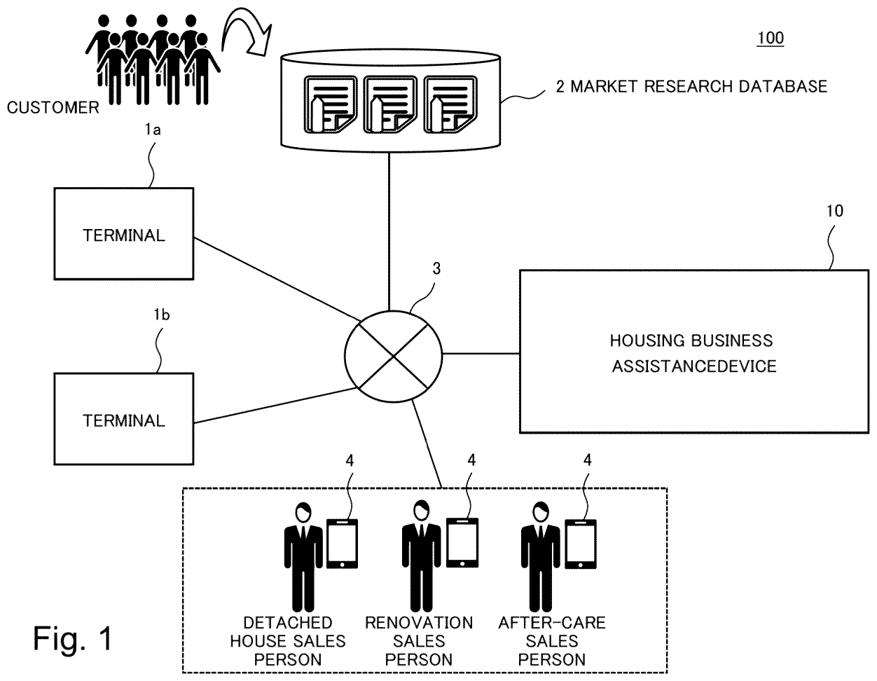

FIG. 1 is a diagram illustrating a schematic configuration of the housing business assistance system 100. As illustrated in FIG. 1, the housing business assistance system 100 includes terminals 1a and 1b, a market research database 2, a housing business assistance device 10, and a sales person terminal 4.

The market research database 2 stores market research data. The market research data is data obtained from all research activities necessary for marketing activities performed by a company. There are various fields such as sales promotion survey, price survey, consumer survey, potential demand survey, sales survey, product survey, sales channel survey, and advertisement survey. The market research data is obtained from market inspection, market analysis, market experiment, and the like. In addition, data used for a purpose different from the field investigation of the market may be utilized as the market investigation data. Although the market research database 2 is connected to the network 3 such as the Internet and the intranet in FIG. 1, the market research database 2 may be connected to the housing business assistance device 10 through a dedicated line or may be stored in the housing business assistance device 10. The market research data stored in the market research database 2 is used, for example, to classify customers into layers.

The housing business assistance device 10 analyzes and outputs measures for efficiently promoting residential business. The housing business assistance device 10 determines a customer group for which measures are to be intensively taken in a housing company (hereinafter referred to as a target company) as a target of business support, and extracts effective measure information for the customer group (sales activity for a certain customer group at a certain time).

The terminals 1a and 1b are communicably connected to the housing business assistance device 10 via the network 3, and operate the housing business assistance device 10. For example, the terminals 1a and 1b input data such as market research data to the housing business assistance device 10, cause the housing business assistance device 10 to analyze the data, and receive measure information that is an analysis result. The terminals 1a and 1b and the housing business assistance device 10 may be directly connected by a dedicated line. The terminals 1a and 1b display the received measure information on a display device (not illustrated) or output the received measure information to physical paper or a storage medium.

The sales person terminal 4 is a portable communication terminal carried by a sales person who conducts residential business. The sales person terminal 4 acquires measure information from the housing business assistance device 10 via the network 3.

(Housing Business Assistance Device)

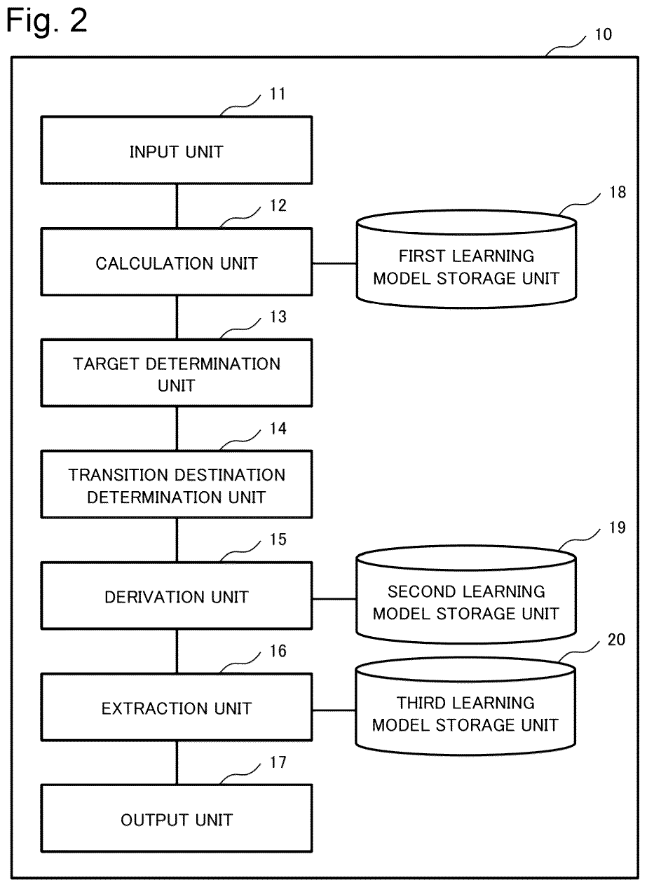

As illustrated in FIG. 2, the housing business assistance device 10 includes an input unit 11, a calculation unit 12, a target determination unit 13, a transition destination determination unit 14, a derivation unit 15, an extraction unit 16, an output unit 17, a first learning model storage unit 18, a second learning model storage unit 19, and a third learning model storage unit 20.

The input unit 11 is an interface that receives an operation related to measure generation from the terminals 1a and 1b. The input unit 11 receives the market research data from the market research database 2 by operation from the terminals 1a and 1b.

The calculation unit 12 calculates a difference (first difference) between a value indicating a customer of a target company and a value indicating a customer of a company other than the target company for each segment obtained by classifying target customers of housing-related business into a plurality of layers. The calculation unit 12 extracts, from the received market research data, recognition, purchase frequency, recent purchase history, future purchase consideration, and the like of the target company and the product in the customers of the target company.

The calculation unit 12 inputs external data (market research data), classifies the customers of the target company and the competitor company into segments, and calculates a value (the number of customers of the target company in each segment, and the percentage or ratio value of the customers) indicating the customer in each segment. For classification of segments, for example, a rule-based approach or a machine learning approach is used.

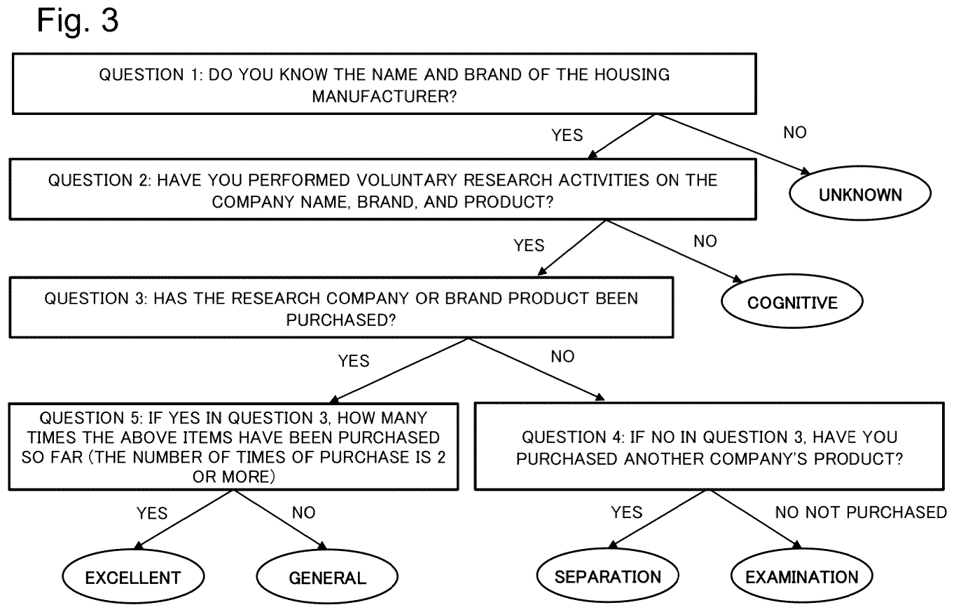

A specific example of classification of segments using the rule-based approach will be described. The calculation unit 12 refers to answers to questions included in the market research data, and classifies customers of a certain house manufacturer into one of segments of an excellent layer, a general layer, a separation layer, an examination layer, a cognitive layer, and an unknown layer. Examples of the question include the following (see FIG. 3).

Question 1: Do you know the name and brand of the housing manufacturer?

Question 2: Have you performed voluntary research activities on the company name, brand, and product?

Question 3: Has the research company or brand product been purchased?

Question 4: In the case of NO in Question 3, have you purchased another company's product?

Question 5: If YES in Question 3, how many times the above items have been purchased so far (the number of times of purchase is 2 or more)

Here, an example of a correspondence relationship between each segment and a question will be described with reference to FIG. 3.

The segment of the unknown layer is a segment of customers who answer “I do not know the company name or brand” (question 1: NO).

The segment of the cognitive layer is a segment of customers who answer “I know the company name and the brand” (question 1: YES) and answer “I have never performed voluntary research” (question 2: NO).

The segment of the separating layer is a segment of customers who answer “I know the company name or brand” (question 1: YES), answer “I have performed voluntary research activities” (question 2: YES), answer “I have not purchased products of the company name or brand that I did research” (question 3: NO), and answer “I purchased products of another company” (question 4: YES).

The segment of the examination layer is a segment of customers who answer “I know the company name or brand” (question 1: YES), answer “I have performed voluntary research activity” (question 2: YES), answer “I have not purchased products of the company name or brand that I have researched” (question 3: NO), and answer “I have not purchased products of another company (I have not purchased products yet)” (question 4: NO).

The segment of the general layer is a segment of customers who answer “I know the company name or brand” (question 1: YES), answer “I have performed voluntary research activities” (question 2: YES), answer “I have purchased products of the company name or brand that I have researched” (question 3: YES), and answer “the number of purchases so far is less than two” (question 5: NO).

The segment of the excellent layer is a segment of customers who answer “I know the company name or brand” (question 1: YES), answer “I have performed voluntary research activity” (question 2: YES), answer “I have purchased products of the company name or brand that I researched” (question 3: YES), and answer “the number of purchases so far is two or more” (question 5: YES).

Depending on the market research data used by the calculation unit 12, an answer to the above question may not be included. In that case, the calculation unit 12 may use a machine learning approach. Hereinafter, a specific example in a case where the calculation unit 12 classifies segments using a machine learning approach will be described.

The calculation unit 12 classifies the customers into segments based on the market research data using the first learning model stored in the first learning model storage unit 18.

Here, the first learning model will be described. The first learning model is a model learned such that recognition, purchase frequency, recent purchase history, future purchase consideration, and the like of the company and the product in each customer of the target company and the competitor company are analyzed using the market research data as an input, and the customers of the target company and the competitor company are classified into segments.

As a learning method of the first learning model, there is a known machine learning method such as a support vector machine (SVM) or a neural network. For example, when the first learning model is a model learned by supervised machine learning, the learning data is data in which a feature amount for each customer extracted from market research data is associated with a segment of the customer.

Here, an example of the feature amount for each customer included in the market research data will be described. An example of the feature amount is customer information. The customer information is information indicating an attribute of the customer itself. The information indicating the attribute of the customer itself is, for example, data including, as items, a customer ID, gender, age, address, occupation, annual income, family structure, presence or absence of land ownership, purchase history (property), customer rank, loan balance, and the like. Note that the customer information is not limited to the above items, and may include other items that may affect the customer's purchasing behavior, such as a social network service (SNS) history.

Another example of the feature amount is land information for each customer. The land information is information indicating an attribute of the land owned by the customer. The information indicating the attribute of the land includes, for example, data including, as items, a location, an area, a use area, ground information, a surrounding environment, a building coverage ratio/volume ratio, an orientation, a road surface, a view/air permeability, and the like. The surrounding environment is information on facilities related to life around a house. The facility is, for example, a commercial facility, a medical facility, a school, a park, or the like. Note that the land information is not limited to the above items, and may include other items that may affect the customer's purchasing behavior.

Yet another example of the feature amount is building information for each customer. The building information is information indicating an attribute of a building owned by a customer. The information indicating the attribute of the building owned by the customer includes, for example, data including a building date (age of a building), a building structure, a total floor area/building area, a floor plan, house performance information, equipment information, garden/garage information, renovation information, and a defect (physical, legal, psychological) as items. The equipment information includes information on electric equipment such as lighting, outlet, and intercom, air-conditioning equipment such as cooling and heating, and a ventilation fan, and water supply and discharge equipment such as a kitchen, a toilet, and a bathroom. The garden/garage information includes information on the presence or absence and size of the garden or garage. The renovation information includes repair of interior and exterior of a building, repair of facilities such as a bath, a toilet, and a kitchen, an amount of repair, and a repair implementation date. The building information is not limited to the above items, and may include other items that may affect the purchasing behavior of the customer.

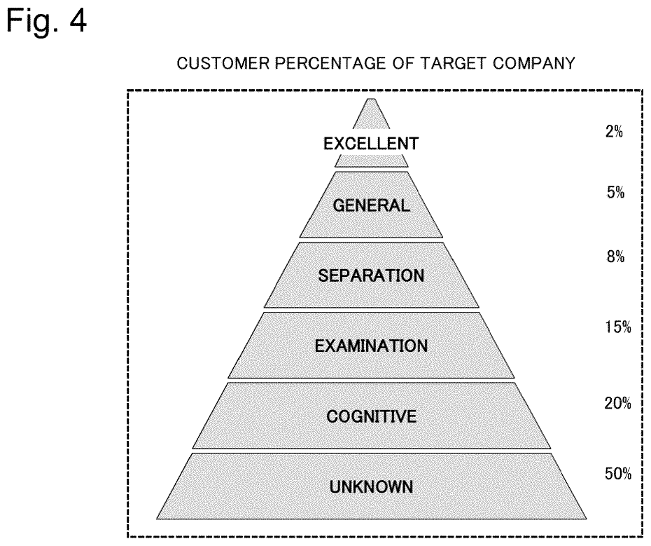

After classifying the customers into segments using the first learning model, the calculation unit 12 aggregates the customers included in each segment. The calculation unit 12 calculates a value indicating the customer in each segment (the number of customers of the target company in each segment or the percentage or ratio value of the customers) (see FIG. 4). Note that, in the case of the machine learning approach, the calculation processing may also be executed by the first learning model. Similarly to the target company, the calculation unit 12 classifies the customers for each segment and calculates a value indicating the customer for the competitor company. Note that not only a value indicating a competitor company but also a value indicating an industry average customer may be used.

The calculation unit 12 calculates a difference (first difference) between the value indicating the customer for each segment of the target company and the value indicating the customer for each segment in the competitor company or the industry average of the target company. The calculation unit 12 transmits the calculated difference to the target determination unit 13.

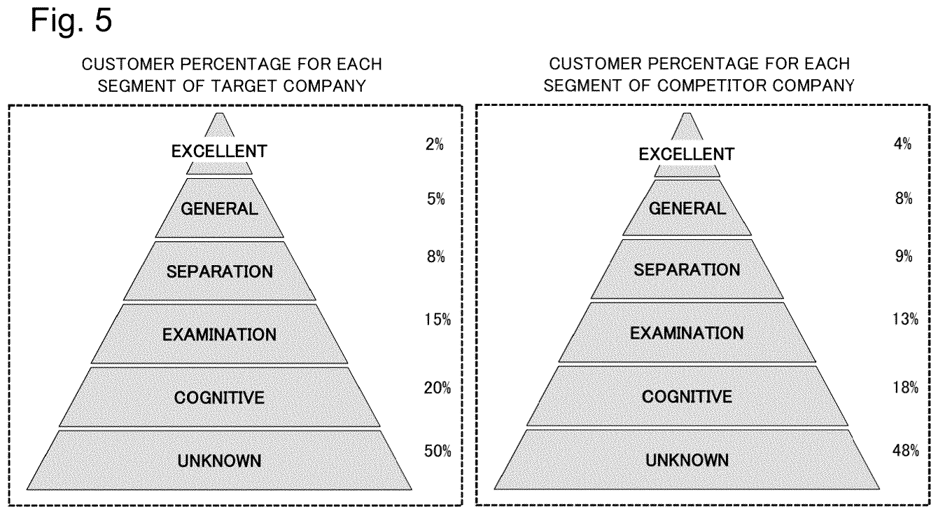

The target determination unit 13 determines a target segment for which measures are to be taken using the difference (first difference) acquired from the calculation unit 12. For example, referring to FIG. 5, the ratio of general customers of the target company is 5%, the ratio of general customers of the competitor company is 8%, and there is a difference of 3%. This is the largest as compared with the difference between other segments. That is, it can be said that it is important to increase the ratio of the general customer segment in order to compete with competitor companies. Therefore, the target determination unit 13 determines the target segment for which measures should be taken as “general customer”. Note that a plurality of target segments may be selected. In the above description, a segment having a large absolute value of the difference is selected as the target segment, but the target segment may be selected using other conditions. The target determination unit 13 transmits the determined target segment to the transition destination determination unit 14.

The transition destination determination unit 14 determines the transition destination segment to which the value indicating the customer in the target segment acquired from the target determination unit 13 should transition. Note that the transition destination segment is, for example, a segment adjacent to an upper level of the target segment. For example, referring to FIG. 4, the segments are arranged as excellent, general, and separation in order from the top, but excellent is above general. Therefore, the transition destination determination unit 14 determines the transition destination segment as “excellent” in order to transition the customer of the general layer to the “excellent” layer. Note that the transition destination determination unit 14 may set a segment not adjacent to the target segment as the transition destination segment. For example, the transition from excellent to separation and the transition from examination to general may be included.

The transition destination determination unit 14 transmits the target segment and the determined transition destination segment to the derivation unit 15.

The derivation unit 15 receives the target segment and the transition destination segment from the transition destination determination unit 14. Using the target segment and the transition destination segment as inputs, the derivation unit 15 derives one or more variables serving as keys in measures. The variable serving as a key in measures is an explanatory variable that affects the difference between the target segment and the transition destination segment and serves as a key to determine the measure to be taken.

The derivation unit 15 acquires the second learning model stored in the second learning model storage unit 19, inputs the target segment and the transition destination segment to the second learning model to extract a variable serving as a key in measures.

Here, the second learning model will be described. The second learning model is a model learned to classify each customer into a target segment or a transition destination segment using market research data regarding the customer as an input.

As a learning method of the second learning model, there are known machine learning methods such as a support vector machine (SVM) and a neural network. For example, when the second learning model is a model learned by supervised machine learning, the learning data is data in which the feature amount for each customer included in the target segment and the transition destination segment extracted from the market research data is associated with the segment of the customer. Here, since the feature amount for each customer is similar to that in the case of the first learning model, the description thereof will be omitted.

In addition, as a learning method of the second learning model, there is heterogeneous mixed learning including FAB inference (Factorized Asymptomatic Bayesian Inference) and the like.

Note that a method of heterogeneous mixed learning is disclosed in, for example, the specification of US 2014/0222741 A. Specifically, the heterogeneous mixed learning generates a model including a plurality of prediction formulas that are classification models and selection conditions of the prediction formulas.

In addition, the second learning model may be generated for the number of routes from the target segment to the transition destination segment. For example, as illustrated in FIG. 4, in a case of a rule in which there are six segments and a segment adjacent to an upper level of a target segment is set as a transition destination segment, five models may be generated because there are five transition routes.

The practice (classification) of the second learning model will be described. For example, the second learning model “general→excellent” classifies the customer into a general segment or an excellent segment based on the feature amount for each customer included in the market research data. A feature amount contributing to this classification is extracted, and the feature amount is set as a “variable serving as a key in measures”.

The derivation unit 15 calculates the degree of importance for each feature amount (explanatory variable) as an input in the second learning model. Specifically, in a case where the second learning model is a linear model, a weighting coefficient for each feature amount serving as an input may be set as the importance.

Furthermore, the derivation unit 15 may use a known machine learning method as a method of calculating the degree of importance of the feature amount to be an input in the second learning model. As a known machine learning method, there is a Feature Importance Light GBM (Light Gradient Boosting Method).

The derivation unit 15 determines a variable serving as a key in measures on the basis of the calculated importance.

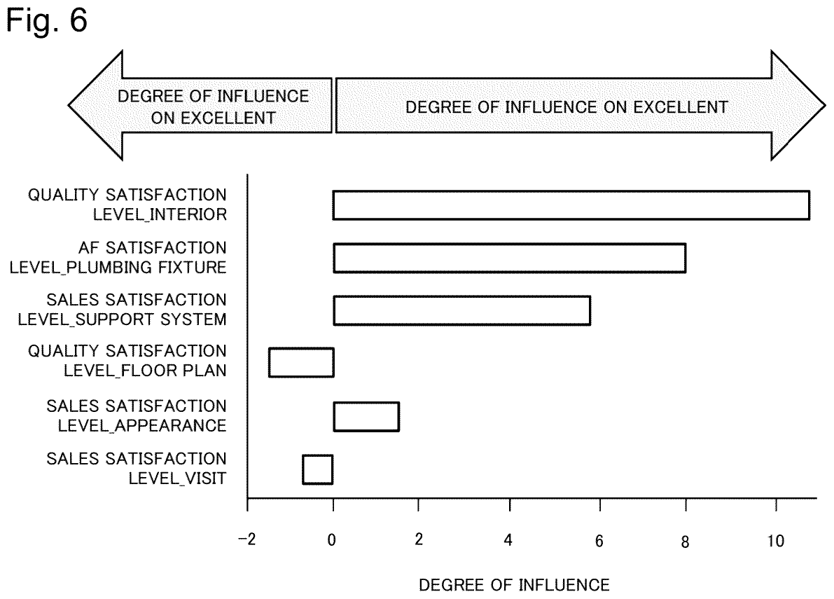

An example of a variable (for example, an explanatory variable) serving as a key in measures will be described with reference to FIG. 6. In the graph of FIG. 6, the vertical axis represents an explanatory variable for a customer to transition to “excellent” or for a customer to continue to be “excellent”, and the horizontal axis represents the degree of influence on “excellent”. Here, it can be seen from the top that explanatory variables indicating a high degree of influence on the excellent are “quality satisfaction level_interior”, “AF (after-care service) satisfaction level_plumbing fixture”, and “sales satisfaction level_support structure”. Therefore, it can be said that these three explanatory variables are important for achieving transition to excellent or maintaining excellent. Note that the derivation unit 15 may determine an explanatory variable having a degree of influence of a predetermined value or more as an important explanatory variable (that is, variables serving as keys in measures). In addition, the values of the degree of influence may be arranged in descending order, and a predetermined number (for example, three) of explanatory variables may be determined as variables serving as keys in measures from the top.

The derivation unit 15 transmits a variable serving as a key in measures to the extraction unit 16.

The extraction unit 16 extracts one or more measure candidates associated with the variables acquired from the derivation unit 15. The extraction unit 16 extracts a measure candidate corresponding to a variable serving as a key in measures from a measure candidate storage unit (not illustrated) that stores the variable serving as the key and the measure candidate in association with each other.

Note that the extraction unit 16 may extract the measure candidate using a third learning model stored in the third learning model storage unit 20.

The extraction unit 16 acquires the third learning model from the third learning model storage unit 20, inputs a variable serving as a key in measures to the third learning model, and causes the third learning model to extract a measure candidate.

As a learning method of the third learning model, there are known machine learning methods such as a support vector machine (SVM) and a neural network. For example, in a case where the third learning model is a model learned by supervised machine learning, the learning data is data in which a feature amount that is a candidate for a variable serving as a key in measures is associated with the measure. Here, since the candidates of the feature amount are similar to those in the case of the first learning model, the description thereof will be omitted.

Note that the third learning model may be generated for the number of routes from the target segment to the transition destination segment.

The practice of the third learning model will be described. For example, the learned third learning model “general→excellent” extracts a measure candidate that has transitioned to excellent from general associated with a variable serving as a key in making a general customer an excellent customer, and a measure candidate that attracts a candidate excellent customer. For example, if the key variable is “quality satisfaction level_interior”, the following are output as the measure candidates: posting many images of interior on the website of the target company; sending a collection of images of interior materials of new products or a collection of images of interior of an existing house to excellent customers or general customers; planning an open house tour to visit a customer's house with interior high in customer satisfaction level; and the like. If the key variable is “AF (after-care service) satisfaction level_plumbing fixture”, planning of a plumbing after-service free campaign, posting on a website of a target company and sending a direct mail of the campaign, and the like are output as measure candidates.

The extraction unit 16 transmits the measure candidate extracted by the third learning model to the output unit 17.

The output unit 17 is a monitor, a printer, an external output port, or the like for outputting data regarding the measure candidates. The output unit 17 outputs the measure candidates received from the extraction unit 16 to a monitor (not illustrated) of the terminals 1a and 1b or to the sales person terminal 4 (see FIG. 1).

The first learning model storage unit 18 stores the learned first learning model in order to classify the customers into segments based on the market research data.

The second learning model storage unit 19 stores the learned second learning model in order to extract a variable serving as a key in measures.

The third learning model storage unit 20 stores the learned third learning model for extracting measure candidates.

As the first to third learning models, learned models are used, but data of execution results of measures may be fed back to the first to third learning models.

(Operation of Housing Business Assistance Device)

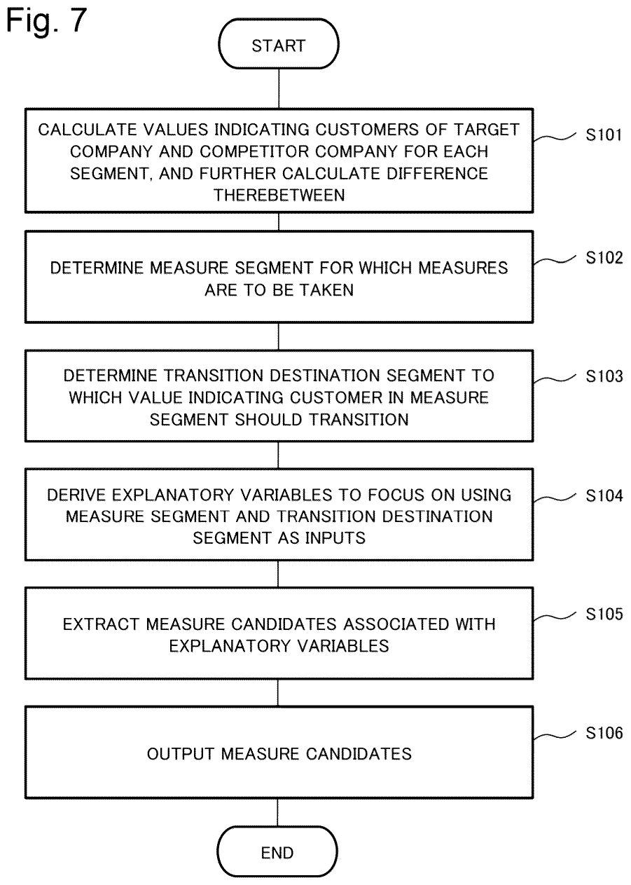

The operation of the housing business assistance device 10 will be described with reference to the flowchart of FIG. 7.

First, in step S101, the calculation unit 12 calculates values indicating the customers of the target company and the competitor company for each segment, and further calculates a difference therebetween. Specifically, the calculation unit 12 receives the market research data from the market research database 2 via the input unit 11, and calculates, for each segment, a difference (first difference) between a value indicating a customer of the target company and a value indicating a customer of a company other than the target company based on the market research data.

Specifically, the calculation unit 12 classifies customers into segments of an excellent layer, a general layer, a separation layer, an examination layer, a cognitive layer, and an unknown layer on the basis of market research data, and calculates values (here, the percentage value of the customer of the target company in each segment) indicating customers in each segment. The calculation unit 12 transmits the calculated difference to the target determination unit 13.

In step S102, the target determination unit 13 determines a target segment for which measures are to be taken using the difference acquired from the calculation unit 12. A plurality of target segments may be selected. The target determination unit 13 transmits the determined target segment to the transition destination determination unit 14.

In step S103, the transition destination determination unit 14 determines the transition destination segment to which the value indicating the customer in the target segment acquired from the target determination unit 13 should transition. The transition destination segment is, for example, a segment adjacent to an upper level of the target segment. The transition destination determination unit 14 transmits the target segment and the determined transition destination segment to the derivation unit 15.

In step S104, using the target segment and the transition destination segment acquired from the transition destination determination unit 14 as inputs, the derivation unit 15 derives one or more variables (for example, an explanatory variable) that serve as keys in measures. The derivation unit 15 transmits the variables to the extraction unit 16.

In step S105, the extraction unit 16 extracts one or more measure candidates associated with the variables acquired from the derivation unit 15. The extraction unit 16 transmits the extracted measure candidates to the output unit 17.

Finally, in step S 105, the output unit 17 that has received the measure candidates outputs the measure candidates to a monitor (not illustrated) of the terminals 1a and 1b or to the sales person terminal 4 (see FIG. 1).

Thus, the housing business assistance device 10 ends the operation.

(Effects of First Example Embodiment)

According to the first example embodiment of the present disclosure, it is possible to support planning of an appropriate measure for an appropriate customer in a housing-related business activity. This is because the calculation unit 12 calculates a first difference between a value indicating a customer of a target company and a value indicating a customer of a company other than the target company for each segment obtained by classifying target customers of housing-related business into a plurality of layers, the target determination unit 13 determines a target segment for which measures should be taken using the first difference, the transition destination determination unit 14 determines a transition destination segment to which a value indicating a customer in the target segment should transition, the derivation unit 15 derives one or more variables serving as keys in the measures using the target segment and the transition destination segment as inputs, and the extraction unit 16 extracts one or more measure candidates associated with the variables.

### Second Example Embodiment

In the first example embodiment, customers are classified into an excellent layer, a general layer, a separation layer, an examination layer, a cognitive layer, and an unknown layer according to the current recognition state and purchase state. However, this indicates the current state of the customer, and it is not possible to determine how the state of the customer changes in the future. For example, even a customer who has been determined to be excellent may have just purchased a product for a negative reason (for example, there was no other product as an option) and may not be an essential excellent customer. Therefore, in the second example embodiment, by newly adding an axis of preference, it is made clear that the customer is either positive or negative in each segment, and eventually, the determination of the measure candidate is made more appropriate.

Specifically, in the second example embodiment, the above layers are further classified by preference to estimate future customer trends. The preference indicates a relative degree of preference of a customer for a brand. When a customer has a good impression on a certain company or a product thereof, the preference is positive, and when a customer has a bad impression on a certain company or a product thereof, the preference is negative. A customer with positive preference purchases a product of the company for an active reason (for example, the user likes the design and function), and further propagates a good reputation for the product (word-of-mouth, posting of a recommended product to a social network service, and the like) to the surroundings in the future. A customer with a negative preference purchases a product of the company for a negative reason (for example, there are no other options), and further propagates a bad reputation for the product (such as word-of-mouth or posting about a product complaint to a social network service) to the surroundings in the future. Preference is determined by three factors: brand equity (a certain image of the brand perceived by consumers), price, and product performance. Therefore, in order to change the future recognition state and purchase state of the customer in a positive direction, it is important to take measures to increase the recognition rate of the target company brand and intentionally build brand equity in which a product of the target company is selected.

Therefore, in the second example embodiment of the present disclosure, a description will be given of the housing business assistance device 30 for improving future recognition states and purchase states of customers classified into an excellent layer, a general layer, a separation layer, an examination layer, a cognitive layer, and an unknown layer.

(Housing Business Assistance Device)

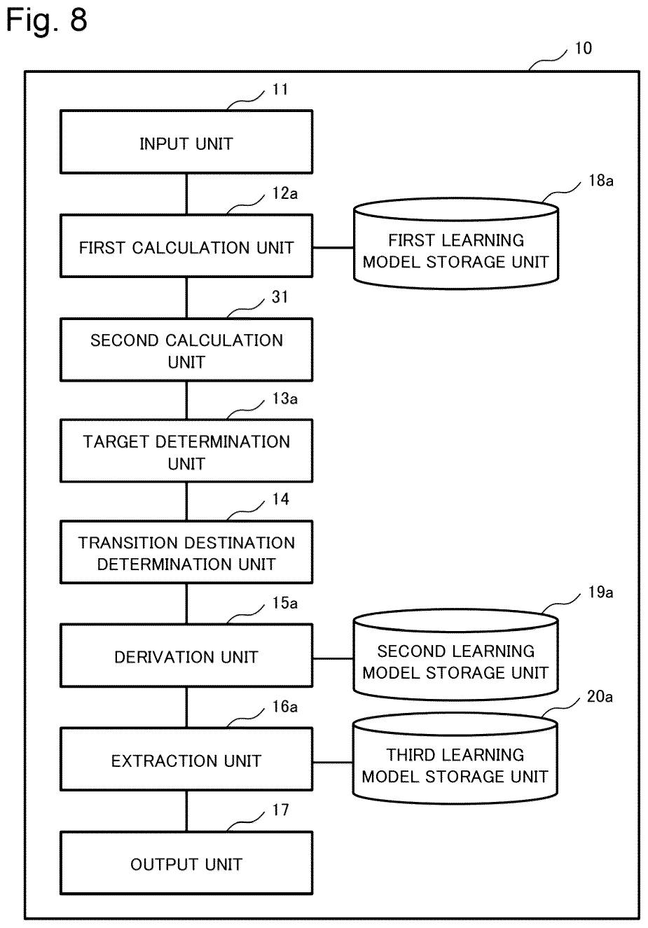

FIG. 8 illustrates an internal structure of the housing business assistance device 30 according to the second example embodiment. Note that each component (the terminals 1a and 1b, market research database 2, network 3, and sales person terminal 4) of the housing business assistance system including the housing business assistance device 30 is similar to that in FIG. 1.

As illustrated in FIG. 8, the housing business assistance device 30 includes an input unit 11, a first calculation unit 12a, a second calculation unit 31, a target determination unit 13a, a transition destination determination unit 14, a derivation unit 15a, an extraction unit 16a, an output unit 17, a first learning model storage unit 18a, a second learning model storage unit 19a, and a third learning model storage unit 20a.

The first calculation unit 12a calculates a difference (first difference) between a value indicating a customer of a target company and a value indicating a customer of a company other than the target company for each segment obtained by dividing target customers of housing-related business into a plurality of layers and degrees of preference. The first calculation unit 12a extracts, from the received market research data, recognition state, purchase frequency, recent purchase history, future purchase consideration, and the like of the target company and the product of the customer of the target company. The first calculation unit 12a classifies the customers into segments using a rule-based approach or a machine learning approach.

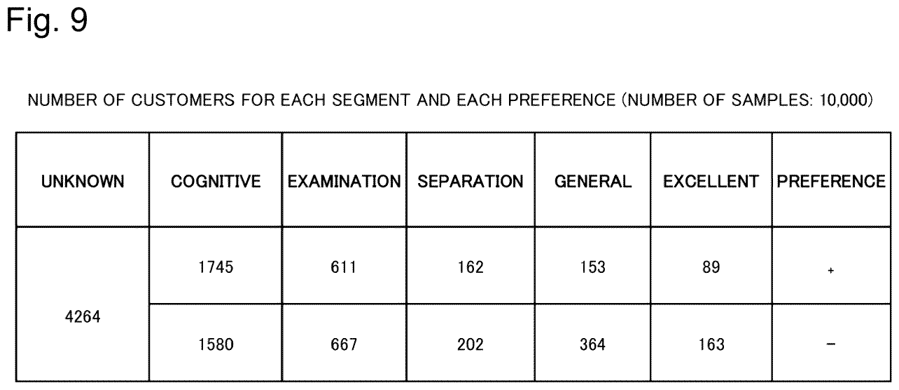

Hereinafter, a case where customers are classified into segments using a machine learning approach will be described. Using the learned first learning model stored in the first learning model storage unit 18a, the first calculation unit 12a classifies the customer into segments of an excellent layer, a general layer, a separation layer, an examination layer, a cognitive layer, and an unknown layer on the basis of the market survey data, and further calculates a value (here, the number of customers) indicating the customer in each segment in which the excellent layer, the general layer, the separation layer, the examination layer, and the cognitive layer are classified by preference (preference positive (+) or preference negative (−)). For example, FIG. 9 shows that the survey samples (10,000) of the customers of the target company are classified into layers, that is, excellent+, excellent−, general+, general−, separation+, separation−, examination+, examination−, cognitive+, cognitive−, and unknown segments. Note that, for the unknown, preference is not applied because a company or a product is not recognized and preference cannot be discriminated. Similarly to the target company, the first calculation unit 12a also classifies the customer for each segment and each preference and calculates a value indicating the customer for a competitor company (which may be an industry average).

As a learning method of the first learning model, there is a known machine learning method such as a support vector machine (SVM) or a neural network.

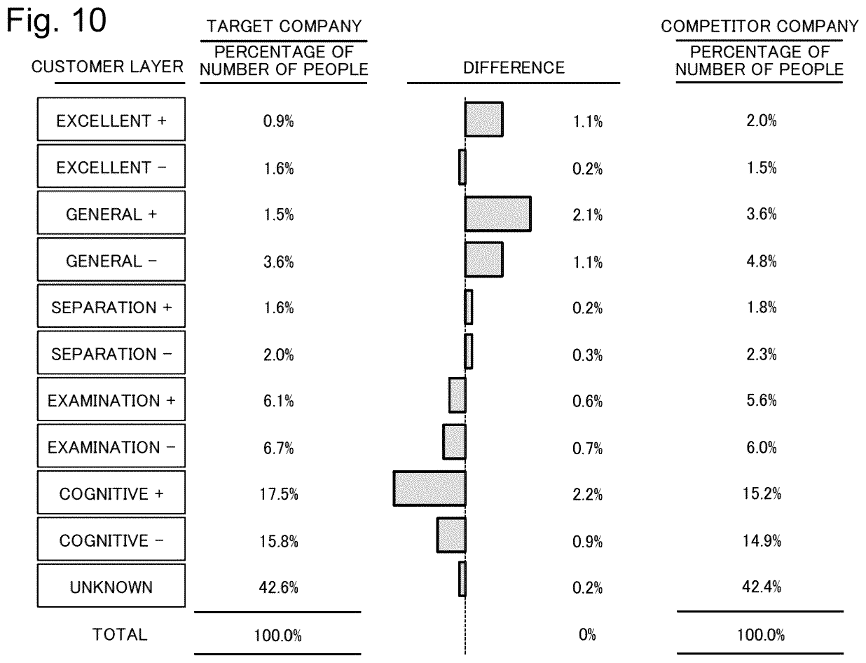

The first calculation unit 12a calculates a value indicating the customer for each segment and each preference of the target company and a value indicating the customer for each segment in the competitor company or the industry average of the target company, and takes a difference therebetween (first difference). FIG. 10 illustrates an example of a calculation result (a value indicating a customer for each segment and each preference of the target company, a value indicating a customer for each segment in a competitor company of the target company, and each first difference) of the first calculation unit 12a. The first calculation unit 12a transmits the calculated first difference to the target determination unit 13a. The first calculation unit 12a transmits a value indicating the customer for each segment and each preference of the target company to the second calculation unit 31.

The second calculation unit 31 receives the value indicating the customer for each segment and each preference of the target company from the first calculation unit 12a, and calculates a difference (second difference) between the value indicating the customer having the positive preference and the value indicating the customer having the negative preference for each customer segment of the target company. That is, the first calculation unit 12a calculates the first difference between the target company and the competitor company, but the second calculation unit 31 calculates the second difference of the value indicating the customer in each of the segments obtained by dividing the customers in the same company (target company) into a plurality of layers and degrees of preference.

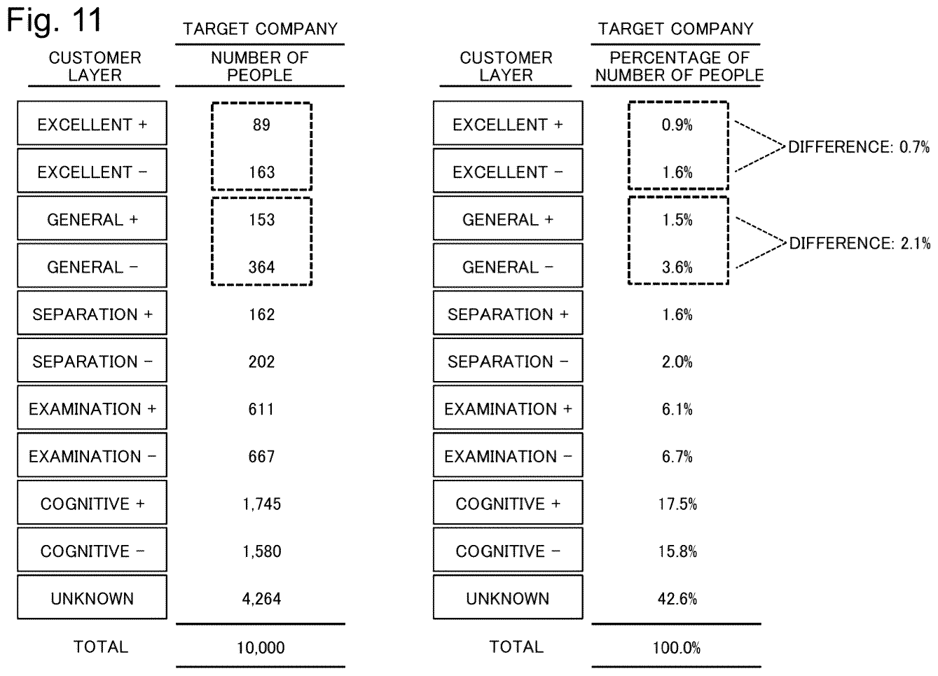

FIG. 11 illustrates an example of the calculation result (the number of people in each segment of the target company and the percentage of the number of people in each segment) of the second calculation unit 31. The second calculation unit 31 transmits the calculated second difference to the target determination unit 13a.

The target determination unit 13a determines a target segment for which measures are to be taken using at least one of the difference (first difference) acquired from the first calculation unit 12a and the difference (second difference) acquired from the second calculation unit 31. For example, referring to FIG. 10, the ratio of general+ customers of the target company is 1.5%, and the ratio of general+ customers of the competitor company is 3.6%, and there is a difference of 2.1%. This is the largest as compared with the difference between other segments. Furthermore, referring to FIG. 11, the ratio of general+ customers and the ratio of general− customers in the target company are 5% and 3.6%, respectively, and there is a difference of 2.1%. This is the largest as compared with the difference between other segments. Therefore, the target company can determine that the ratio of the segments of the general+ customers should be increased. Therefore, the target determination unit 13a determines the target segment for which measures should be taken as a “general+” customer.

The target determination unit 13a may determine the target segment for which measures are to be taken on the basis of a difference having a larger absolute value between the first difference and the second difference. Although the target segment is determined on the basis of the magnitude of the absolute value of the difference in the above description, the target determination unit 13a may determine the target segment on the basis of other conditions. The target determination unit 13a may perform predetermined calculation processing on the first difference and the second difference (for example, an average value is taken), and determine the target segment for which measures are to be taken based on the calculation result. Note that a plurality of target segments may be selected. The target determination unit 13a transmits the determined target segment to the transition destination determination unit 14.

The transition destination determination unit 14a determines the transition destination segment to which the value indicating the customer in the target segment acquired from the target determination unit 13a should transition. For example, the transition destination segment is a segment adjacent to an upper level of the target segment. For example, referring to FIG. 10, the segments are arranged as excellent+, excellent−, general+, and general− in order from the top, but since general+ is above (next to) general−, the transition destination determination unit 14 determines the transition destination segment as “general+” in order to transition the customer of the “general−” layer to the “general+” layer. Note that the transition destination determination unit 14a may set a segment not adjacent to the target segment as the transition destination segment. The transition destination determination unit 14a transmits the target segment and the determined transition destination segment to the derivation unit 15a.

The derivation unit 15a receives the target segment and the transition destination segment from the transition destination determination unit 14. The derivation unit 15a uses the target segment and the transition destination segment as inputs, and derives one or more variables (for example, an explanatory variable) that affect the difference between the target segment and the transition destination segment and serve as keys to determine measures to be taken. Specifically, the derivation unit 15a acquires the learned second learning model stored in the second learning model storage unit 19, and causes the second learning model to extract a variable serving as a key in measures using the target segment and the transition destination segment.

As a learning method of the second learning model, there are known machine learning methods such as a support vector machine (SVM) and a neural network.

The second learning model may be generated for the number of routes from the target segment to the transition destination segment.

For example, the learned second learning model “general−→general+” derives an explanatory variable serving as a point in transitioning the general− customer to the general+ customer. Note that the second learning model may be learned so as to derive an explanatory variable for a transition (for example, “general−→excellent+”) to a different segment.

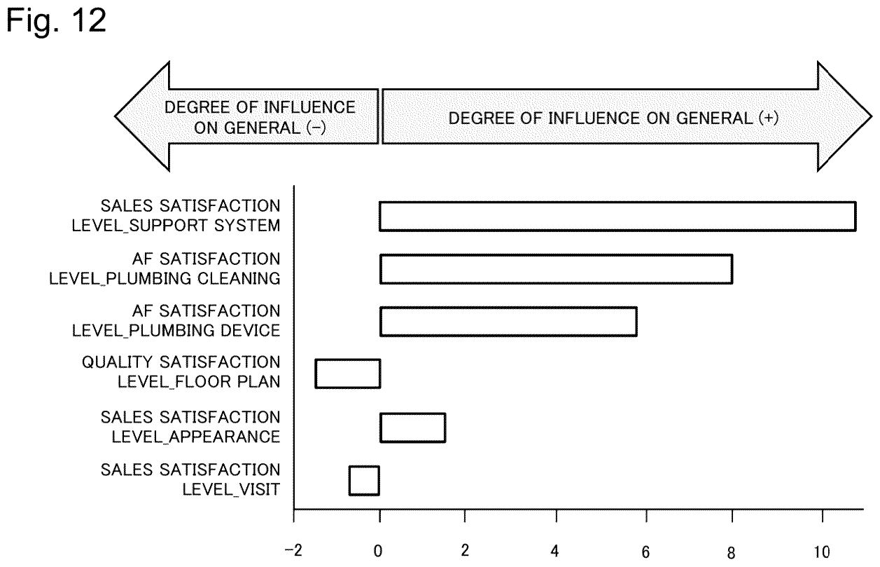

An example of variables serving as keys in measures will be described with reference to FIG. 12. In the graph of FIG. 12, the vertical axis represents an explanatory variable for the customer to transition from “general−” to “general+”, and the horizontal axis represents “degree of influence on general− or general−”. Here, it can be seen from the top that explanatory variables indicating a high degree of influence on “general+” are “sales satisfaction level_support system”, “AF (after-care service) satisfaction level_plumbing cleaning”, and “AF (after-care service) satisfaction level_plumbing fixture”. Therefore, it can be said that these three explanatory variables are important for the transition to general+. Note that an explanatory variable having a degree of influence of a predetermined value or more may be determined as an important explanatory variable (that is, a variable serving as a key in measures). In addition, the values of the degrees of influence may be arranged in descending order, and a predetermined number (for example, three) of explanatory variables from the top may be determined as important explanatory variables. The important explanatory variable may be determined by another method. The derivation unit 15a transmits the explanatory variable to the extraction unit 16a.

The extraction unit 16a extracts one or more measure candidates associated with the variables acquired from the derivation unit 15a. The extraction unit 16a extracts a measure candidate corresponding to a variable serving as a key in measures from a measure candidate storage unit (not illustrated) that stores the variable serving as the key and the measure candidate in association with each other.

Note that the extraction unit 16a may extract measure candidates using the learned third learning model stored in the third learning model storage unit 20a. The extraction unit 16a acquires a third learning model from the third learning model storage unit 20a, inputs a variable serving as a key in measures to the third learning model, and causes the third learning model to extract a measure candidate.

As a learning method of the third learning model, there are known machine learning methods such as a support vector machine (SVM) and a neural network.

The third learning model may be generated for the number of routes from the target segment to the transition destination segment.

For example, the third learning model “general−→general+” extracts a measure candidate associated with an important explanatory variable in transitioning the general− customer to the general+ customer. Here, if the explanatory variable is, for example, “sales satisfaction level_support system”, a measure to appeal the features of the support system of sales to general customers is planned. For example, differentiating the thickness of support from other companies and posting it on a website, closely contacting customers after purchasing a product, and the like are output as measure candidates. If the explanatory variables are “AF (after-care service) satisfaction level_plumbing cleaning” and “AF (after-care service) satisfaction level_plumbing fixture”, measures to appeal the features of the plumbing service to general customers are planned. For example, since the general+ customer is satisfied with the service related to the plumbing of the target company (for example, drainage groove cleaning or replacement of a water supply appliance), a discount campaign and a free campaign of a plumbing device replacement or a cleaning service for the general− customer are output as the measure candidates.

The extraction unit 16a transmits the measure candidate extracted by the third learning model to the output unit 17.

The other parts are the same as those in the first example embodiment (see FIG. 2).

(Operation of Housing Business Assistance Device)

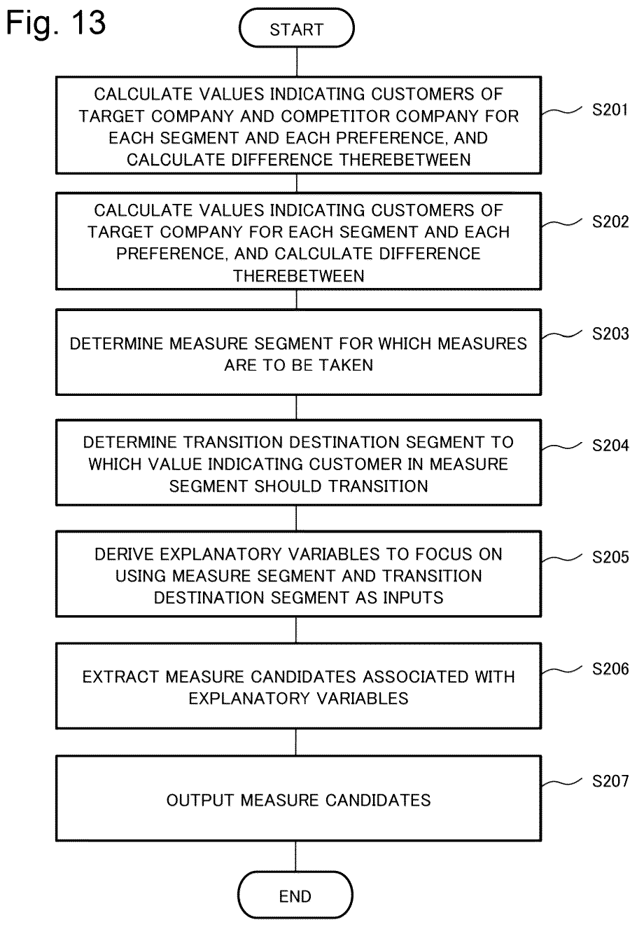

The operation of the housing business assistance device 30 will be described with reference to the flowchart of FIG. 13.

First, in step 5201, the first calculation unit 12a calculates values indicating customers of the target company and the competitor company for each segment and each preference, and further calculates a difference therebetween. The first calculation unit 12a receives market research data from the market research database 2 via the input unit 11, and calculates a difference (first difference) between a value indicating a customer of a target company and a value indicating a customer of a company other than the target company for each segment and each preference based on the market research data.

Specifically, the first calculation unit 12a classifies the customers of the target company and the competitor company into excellent+, excellent−, general+, general−, separation+, separation−, examination+, examination−, cognitive+, cognitive−, and unknown segments on the basis of the market research data, and calculates a value indicating the customer in each segment (percentage value of the customer of the target company in each segment). The first calculation unit 12a calculates a difference (first difference) between a value indicating a customer of a target company and a value indicating a customer of a company other than the target company, and transmits the calculated difference to the target determination unit 13a.

In step S202, the second calculation unit 31 calculates the second difference between the value indicating the customer having the positive preference and the value indicating the customer having the negative preference for each customer segment of the target company. Specifically, the second calculation unit 31 receives the market research data from the market research database 2 via the input unit 11, calculates the value indicating the customer of each segment of the target company for each segment and each preference of the target company based on the market research data, and calculates the difference (second difference) of the values indicating the customers for each adjacent segment. The second calculation unit 31 may acquire, from the first calculation unit 12a, values indicating customers in excellent+, excellent−, general+, general−, separation+, separation−, examination+, examination−, cognitive+, cognitive−, and unknown segments of the target company, and calculate a difference. The second calculation unit 31 transmits the calculated second difference to the target determination unit 13a.

In step S203, the target determination unit 13a determines a target segment for which measures are to be taken using the first difference acquired from the first calculation unit 12a and the second difference acquired from the second calculation unit 31. A plurality of target segments may be selected. The target determination unit 13a transmits the determined target segment to the transition destination determination unit 14.

In step S204, the transition destination determination unit 14 determines the transition destination segment to which the value indicating the customer in the target segment acquired from the target determination unit 13a should transition. The transition destination segment is, for example, a segment adjacent to an upper level of the target segment. The transition destination determination unit 14 transmits the target segment and the determined transition destination segment to the derivation unit 15a.

In step S205, the derivation unit 15a derives one or more variables (for example, explanatory variables) that serve as keys in measures, using the target segment and the transition destination segment acquired from the transition destination determination unit 14 as inputs. The derivation unit 15a transmits the variables to the extraction unit 16a.

In step S206, the extraction unit 16a extracts one or more measure candidates associated with the variables acquired from the derivation unit 15a. The extraction unit 16a transmits the extracted measure candidates to the output unit 17.

Finally, in step S207, the output unit 17 that has received the measure candidates outputs the measure candidates to a monitor (not illustrated) of the terminals 1a and 1b or to the sales person terminal 4 (see FIG. 1). The terminals 1a and 1b and the sales person terminal 4 may output the measure candidates to physical paper or a storage medium.

Thus, the housing business assistance device 30 ends the operation.

(Effects of Second Example Embodiment)

According to the second example embodiment of the present disclosure, as compared with the first example embodiment, it is possible to support planning of appropriate measures more appropriately for an appropriate customer in housing-related business activities. This is because the first calculation unit 12a calculates a first difference between a value indicating a customer of a target company and a value indicating a customer of a company other than the target company for each segment obtained by classifying target customers of housing-related business into a plurality of layers, the second calculation unit 31 calculates a second difference between a value indicating a customer having a positive preference and a value indicating a customer having a negative preference for each customer segment of the target company, the target determination unit 13a determines a target segment using the first difference and the second difference, the transition destination determination unit 14 determines a transition destination segment to which a value indicating a customer in the target segment should transition, the derivation unit 15a derives one or more variables serving as keys in measures using the target segment and the transition destination segment as inputs, and the extraction unit 16a extracts one or more measure candidates associated with the variables.

### Third Example Embodiment

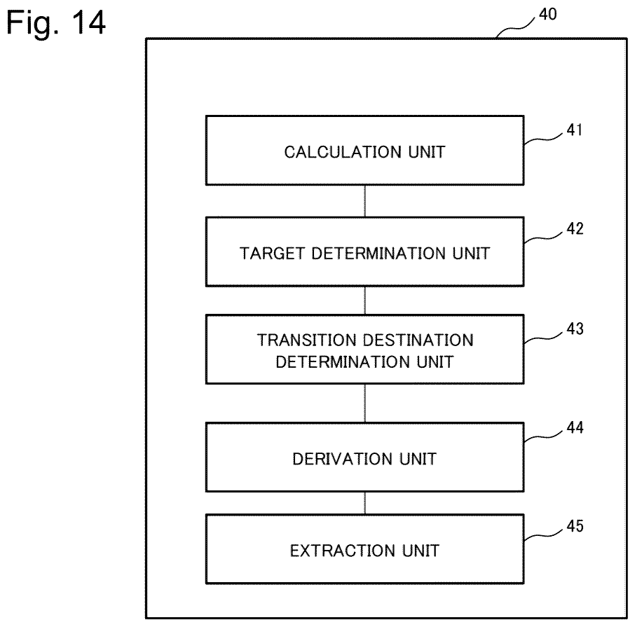

As illustrated in FIG. 14, a housing business assistance device 40 according to a third example embodiment of the present disclosure includes a calculation unit 41, a target determination unit 42, a transition destination determination unit 43, a derivation unit 44, and an extraction unit 45. The housing business assistance device 40 is a minimum configuration example of the housing business assistance devices 10 and 30 in the first and second example embodiments.

The calculation unit 41 calculates a difference (first difference) between a value indicating a customer of a target company and a value indicating a customer of a company other than the target company for each segment obtained by classifying target customers of housing-related business into a plurality of layers. The segments include an excellent layer, a general layer, a separation layer, an examination layer, a cognitive layer, and an unknown layer. The calculation unit 41 calculates, for each segment, a first difference between a value (number of customers in each segment, percentage of customers, or the like) indicating a customer of a target company and a value indicating a customer of a competitor company of the target company.

The target determination unit 42 determines a target segment for which measures are to be taken using the first difference. For example, a segment having a large first difference indicates that the values of the target company and the competitor company are different from each other. Therefore, in order to bring the customer percentage closer to that of the competitor company, the target company determines a segment having a large first difference as the target segment.

The transition destination determination unit 43 determines the transition destination segment to which the value indicating the customer of the target company in the target segment should transition. In order to bring the customer percentage closer to that of the competitor company, the target company needs to move the customer percentage of the target segment having the large first difference to any segment. Normally, since the segments are arranged as excellent→general→separation, and the like, if the target segment is general, the segment to which the customer percentage of the target company should transition is an excellent segment. Therefore, the transition destination determination unit 43 determines “excellent” as the transition destination segment.

Using the target segment and the transition destination segment as inputs, the derivation unit 44 derives one or more variables serving as keys in measures. The derivation unit 44 inputs the target segment and the transition destination segment to the second learning model and outputs one or more variables estimated to be highly related to the movement of the customer from the target segment to the transition destination segment.

The extraction unit 45 extracts one or more measure candidates associated with the variables. The extraction unit 45 inputs a variable serving as a key in measures to the third learning model and causes the third learning model to extract measure candidates.

According to the third example embodiment of the present disclosure, it is possible to support planning of an appropriate measure for an appropriate customer in housing-related business activities. This is because the calculation unit 41 calculates a first difference between a value indicating a customer of a target company and a value indicating a customer of a company other than the target company for each segment obtained by classifying target customers of housing-related business into a plurality of layers, the target determination unit 42 determines a target segment for which measures should be taken using the first difference, the transition destination determination unit 43 determines a transition destination segment to which a value indicating a customer of the target company in the target segment should transition, the derivation unit 44 derives one or more variables to be keys in the measures using the target segment and the transition destination segment as inputs, and the extraction unit 45 extracts one or more measure candidates associated with the variables.

(Information Processing Device)

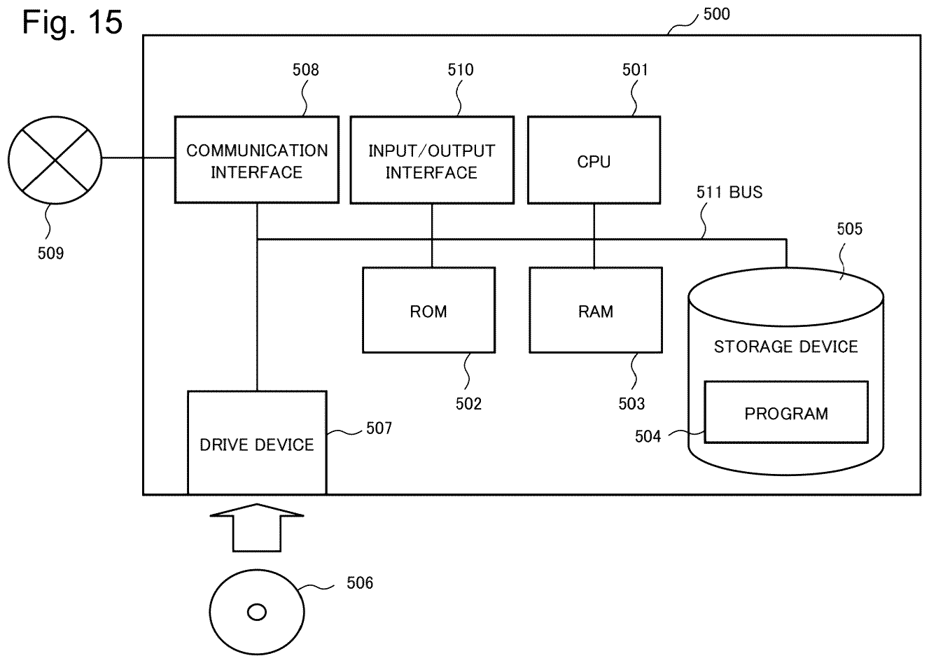

In each example embodiment of the present invention described above, some or all of the respective components in the housing business assistance device illustrated in FIGS. 2, 8, 14, and the like can also be achieved using, for example, an arbitrary combination of an information processing device 500 and the program as illustrated in FIG. 15. The information processing device 500 includes the following configuration as an example.
CPU 501
ROM 502
RAM 503
Storage device 505 storing program 504 and other data
Drive device 507 that reads and writes recording medium 506
Communication interface 508 connected with communication network 509
Input/output interface 510 for inputting/outputting data
Bus 511 connecting respective components

Each component of the housing business assistance device in each example embodiment of the present application is achieved by the CPU 501 acquiring and executing the program 504 for realizing these functions. The program 504 that implements the functions of the components of the housing business assistance device is stored in advance in the storage device 505 or the RAM 503, for example, and is read by the CPU 501 as necessary. Note that the program 504 may be supplied to the CPU 501 via the communication network 509, or may be stored in advance in the recording medium 506, and the drive device 507 may read the program and supply the program to the CPU 501.

There are various modifications of the implementation method of each device. For example, the housing business assistance device may be achieved by an arbitrary combination of a separate information processing device and program for each component. In addition, a plurality of components included in the housing business assistance device may be achieved by an arbitrary combination of one information processing device 500 and a program.

In addition, some or all of the respective components of the housing business assistance device are achieved by other general-purpose or dedicated circuits, processors, or the like, or a combination thereof. These may be configured by a single chip or may be configured by a plurality of chips connected via a bus.

Some or all of the components of the housing business assistance device may be achieved by a combination of the above-described circuit and the like and a program.

In a case where some or all of the components of the housing business assistance device are achieved by a plurality of information processing devices, circuits, and the like, the plurality of information processing devices, circuits, and the like may be arranged in a centralized manner or in a distributed manner. For example, the information processing device, the circuit, and the like may be achieved as a form in which each is connected via a communication network, such as a client and server system or a cloud computing system.

Some or all of the above example embodiments may be described as the following supplementary notes, but are not limited to the following.

### Supplementary Note 1

A housing business assistance device includes:
a calculation unit configured to calculate a first difference between a value indicating a customer of a target company and a value indicating a customer of a company other than the target company for each segment obtained by classifying target customers of a housing-related business into a plurality of layers;
a target determination unit configured to determine a target segment for which measures are to be taken using the first difference;
a transition destination determination unit configured to determine a transition destination segment to which a value indicating a customer of the target company in the target segment should transition;
a derivation unit configured to derive one or more variables serving as keys in the measures using the target segment and the transition destination segment as inputs; and
an extraction unit configured to extract one or more measure candidates associated with the variables.

### Supplementary Note 2

The housing business assistance device according to supplementary note 1, wherein
the layers include at least one of an excellent layer, a general layer, a separation layer, an examination layer, a cognitive layer, and an unknown layer.

### Supplementary Note 3

The housing business assistance device according to supplementary note 2, wherein
the excellent layer, the general layer, the separation layer, the examination layer, and the cognitive layer among the layers are divided by preference.

### Supplementary Note 4

The housing business assistance device according to supplementary note 3, wherein
the preference is either a positive preference or a negative preference.

### Supplementary Note 5

The housing business assistance device according to supplementary note 4, further includes:
a second calculation unit configured to calculate a second difference between a value indicating a customer having the positive preference and a value indicating a customer having the negative preference for each segment of the target company, wherein
the target determination unit determines the target segment using at least one of the first difference and the second difference.

### Supplementary Note 6

The housing business assistance device according to supplementary note 1, wherein
the calculation unit inputs external data to a first learning model, classifies customers of the target company and customers of the company other than the target company for each segment, and calculates a value indicating a customer in each segment.

### Supplementary Note 7

The housing business assistance device according to supplementary note 1, wherein
the derivation unit inputs the target segment and the transition destination segment to a second learning model to extract the variable.

### Supplementary Note 8

The housing business assistance device according to supplementary note 1, wherein
the extraction unit inputs the variable to a third learning model to extract the measure candidates.

### Supplementary Note 9

The housing business assistance device according to supplementary note 1, wherein
the transition destination segment is a segment adjacent to the target segment.

### Supplementary note 10

A housing business assistance method includes:
calculating a first difference between a value indicating a customer of a target company and a value indicating a customer of a company other than the target company for each segment obtained by classifying target customers of a housing-related business into a plurality of layers;
determining a target segment for which measures are to be taken using the first difference;
determining a transition destination segment to which a value indicating a customer of the target company in the target segment should transition;
deriving one or more variables serving as keys in the measures using the target segment and the transition destination segment as inputs; and
extracting one or more measure candidates associated with the variables.

### Supplementary Note 11

The housing business assistance method according to supplementary note 10, wherein
the layers include at least one of an excellent layer, a general layer, a separation layer, an examination layer, a cognitive layer, and an unknown layer.

### Supplementary Note 12

The housing business assistance method according to supplementary note 11, wherein
the excellent layer, the general layer, the separation layer, the examination layer, and the cognitive layer among the layers are divided by preference.

### Supplementary Note 13

The housing business assistance method according to supplementary note 12, wherein
the preference is either a positive preference or a negative preference.

### Supplementary Note 14

The housing business assistance method according to supplementary note 13, further includes:
calculating a second difference between a value indicating a customer having the positive preference and a value indicating a customer having the negative preference for each segment of the target company, wherein
the determining of the target segment includes determining the target segment using at least one of the first difference and the second difference.

### Supplementary Note 15

The housing business assistance method according to supplementary note 10, wherein
the calculating of the first difference includes inputting external data to a first learning model, classifying customers of the target company and customers of the company other than the target company for each segment, and calculating a value indicating a customer in each segment.

### Supplementary Note 16

The housing business assistance method according to supplementary note 10, wherein
the deriving includes inputting the target segment and the transition destination segment to a second learning model to extract the variable.

### Supplementary Note 17

The housing business assistance method according to supplementary note 10, wherein
the extracting includes inputting the variable to a third learning model to extract the measure candidates.

### Supplementary Note 18

The housing business assistance method according to supplementary note 10, wherein
the transition destination segment is a segment adjacent to the target segment.

### Supplementary Note 19

A recording medium storing a housing business assistance program for causing a computer to achieve:
calculating a first difference between a value indicating a customer of a target company and a value indicating a customer of a company other than the target company for each segment obtained by classifying target customers of a housing-related business into a plurality of layers;
determining a target segment for which measures are to be taken using the first difference;
determining a transition destination segment to which a value indicating a customer of the target company in the target segment should transition;
deriving one or more variables serving as keys in the measures using the target segment and the transition destination segment as inputs; and
extracting one or more measure candidates associated with the variables.

### Supplementary Note 20

The recording medium according to supplementary note 19, wherein
the layer includes at least one of an excellent layer, a general layer, a separation layer, an examination layer, a cognitive layer, and an unknown layer.

### Supplementary Note 21

The recording medium according to supplementary note 20, wherein
the excellent layer, the general layer, the separation layer, the examination layer, and the cognitive layer among the layers are divided by preference.

### Supplementary Note 22

The recording medium according to supplementary note 21, wherein
the preference is either a positive preference or a negative preference.

### Supplementary Note 23

The recording medium according to supplementary note 22, further includes:
calculating a second difference between a value indicating a customer having the positive preference and a value indicating a customer having the negative preference for each segment of the target company, wherein
the determining of the target segment includes determining the target segment using at least one of the first difference and the second difference.

### Supplementary Note 24

The recording medium according to supplementary note 19, wherein
the calculating of the first difference includes inputting external data to a first learning model, classifying customers of the target company and customers of the company other than the target company for each segment, and calculating a value indicating a customer in each segment.

### Supplementary Note 25

The recording medium according to supplementary note 19, wherein
the deriving includes inputting the target segment and the transition destination segment to a second learning model to extract the variables.

### Supplementary Note 26

The recording medium according to supplementary note 19, wherein
the extracting includes inputting the variables to a third learning model to extract the measure candidates.

### Supplementary Note 27

The recording medium according to supplementary note 19, wherein
the transition destination segment is a segment adjacent to the target segment.

Although the present invention has been described above with reference to the present embodiment, the present invention is not limited to the above embodiment. Various modifications that can be understood by those skilled in the art can be made to the configuration and details of the present invention within the scope of the present invention.

### REFERENCE SIGNS LIST

1a TERMINAL
1b TERMINAL
2 MARKET RESEARCH DATABASE
3 NETWORK
4 SALES PERSON TERMINAL
10 HOUSING BUSINESS ASSISTANCE DEVICE
11 INPUT UNIT
12 CALCULATION UNIT
12a FIRST CALCULATION UNIT
13 TARGET DETERMINATION UNIT
13a TARGET DETERMINATION UNIT
14 TRANSITION DESTINATION DETERMINATION UNIT
14a TRANSITION DESTINATION DETERMINATION UNIT
15 DERIVATION UNIT
15a DERIVATION UNIT
16 EXTRACTION UNIT
16a EXTRACTION UNIT
17 OUTPUT UNIT
18 FIRST LEARNING MODEL STORAGE UNIT
18a FIRST LEARNING MODEL STORAGE UNIT
19 SECOND LEARNING MODEL STORAGE UNIT
19a SECOND LEARNING MODEL STORAGE UNIT
20 THIRD LEARNING MODEL STORAGE UNIT
20a THIRD LEARNING MODEL STORAGE UNIT
30 HOUSING BUSINESS ASSISTANCE DEVICE
31 SECOND CALCULATION UNIT
40 HOUSING BUSINESS ASSISTANCE DEVICE
41 CALCULATION UNIT
42 TARGET DETERMINATION UNIT
43 TRANSITION DESTINATION DETERMINATION UNIT
44 DERIVATION UNIT
45 EXTRACTION UNIT
100 HOUSING BUSINESS ASSISTANCE SYSTEM
500 INFORMATION PROCESSING DEVICE
501 CPU
502 ROM
503 RAM
504 PROGRAM
505 STORAGE DEVICE
506 RECORDING MEDIUM
507 DRIVE DEVICE
508 COMMUNICATION INTERFACE
509 COMMUNICATION NETWORK
510 INPUT/OUTPUT INTERFACE
511 BUS

What is claimed is:

1. A housing business assistance device comprising:
a memory; and
at least one processor coupled to the memory,
the processor performing operations, the operations comprising:
calculating a first difference between a value indicating a customer of a target company and a value indicating a customer of a company other than the target company for each segment obtained by classifying target customers of a housing-related business into a plurality of layers;
determining a target segment for which measures are to be taken using the first difference;
determining a transition destination segment to which a value indicating a customer of the target company in the target segment transitions;
deriving one or more variables serving as keys in the measures using the target segment and the transition destination segment as inputs; and
extracting one or more measure candidates associated with the variables.

2. The housing business assistance device according to claim 1, wherein
the layers include at least one of an excellent layer, a general layer, a separation layer, an examination layer, a cognitive layer, and an unknown layer.

3. The housing business assistance device according to claim 2, wherein
the excellent layer, the general layer, the separation layer, the examination layer, and the cognitive layer among the layers are divided by preference.

4. The housing business assistance device according to claim 3, wherein
the preference is either a positive preference or a negative preference.

5. The housing business assistance device according to claim 4, wherein the operations further comprise:
calculating a second difference between a value indicating a customer having the positive preference and a value indicating a customer having the negative preference for each segment of the target company; and
determining the target segment using at least one of the first difference and the second difference.

6. The housing business assistance device according to claim 1, wherein the operations further comprise:
inputting external data to a first learning model, classifying customers of the target company and customers of the company other than the target company for each segment, and calculating a value indicating a customer in each segment.

7. The housing business assistance device according to claim 1, wherein the operations further comprise:
inputting the target segment and the transition destination segment to a second learning model to extract the variable.

8. The housing business assistance device according to claim 1, wherein the operations further comprise:
inputting the variable to a third learning model to extract the measure candidates.

9. The housing business assistance device according to claim 1, wherein
the transition destination segment is a segment adjacent to the target segment.

10. A housing business assistance method comprising:
calculating a first difference between a value indicating a customer of a target company and a value indicating a customer of a company other than the target company for each segment obtained by classifying target customers of a housing-related business into a plurality of layers;
determining a target segment for which measures are to be taken using the first difference;
determining a transition destination segment to which a value indicating a customer of the target company in the target segment should transition transitions;
deriving one or more variables serving as keys in the measures using the target segment and the transition destination segment as inputs; and
extracting one or more measure candidates associated with the variables.

11. The housing business assistance method according to claim 10, wherein
the layers include at least one of an excellent layer, a general layer, a separation layer, an examination layer, a cognitive layer, and an unknown layer.

12. The housing business assistance method according to claim 11, wherein
the excellent layer, the general layer, the separation layer, the examination layer, and the cognitive layer among the layers are divided by preference.

13. The housing business assistance method according to claim 12, wherein
the preference is either a positive preference or a negative preference.

14. The housing business assistance method according to claim 13, further comprising:
calculating a second difference between a value indicating a customer having the positive preference and a value indicating a customer having the negative preference for each segment of the target company; and
determining the target segment using at least one of the first difference and the second difference.

15. The housing business assistance method according to claim 10, further comprising:
inputting external data to a first learning model, classifying customers of the target company and customers of the company other than the target company for each segment, and calculating a value indicating a customer in each segment.

16. The housing business assistance method according to claim 10, further comprising:
inputting the target segment and the transition destination segment to a second learning model to extract the variable.

17. The housing business assistance method according to claim 10, further comprising:
inputting the variable to a third learning model to extract the measure candidates.

18. The housing business assistance method according to claim 10, wherein
the transition destination segment is a segment adjacent to the target segment.

19. A non-transitory computer-readable recording medium embodying a housing business assistance program for causing a computer to perform a method, the method comprising:
calculating a first difference between a value indicating a customer of a target company and a value indicating a customer of a company other than the target company for each segment obtained by classifying target customers of a housing-related business into a plurality of layers;
determining a target segment for which measures are to be taken using the first difference;
determining a transition destination segment to which a value indicating a customer of the target company in the target segment transitions;
deriving one or more variables serving as keys in the measures using the target segment and the transition destination segment as inputs; and
extracting one or more measure candidates associated with the variables.

20. The recording medium according to claim 19, wherein
the layer includes at least one of an excellent layer, a general layer, a separation layer, an examination layer, a cognitive layer, and an unknown layer.

21-27. (canceled)
